(19) United States
(12) Patent Application Publication
(10) Pub. No.: US 2017/0361417 A1
(43) Pub. Date: Dec. 21, 2017

(54) GRINDING DEVICE

(71) Applicant: Picote Oy Ltd., Porvoo (FI)

(72) Inventor: Mika Lokkinen, Porvoo (FI)

(21) Appl. No.: 15/186,948

(22) Filed: Jun. 20, 2016

(51) Int. Cl. B24B 27/027; B24D 7/06; B24D 7/16; F16L 55/26

(52) U.S. Cl. CPC B24B 27/027; F16L 55/26; B24D 7/06; B24D 7/16

(57) ABSTRACT

The grinding device is for removing a collapsed liner inside a pipe. The grinding device has a connector for a drive shaft, a body rotatable around a rotation axis with the drive shaft and grinding cutters attached to the body. The grinding cutters have cutting edges provided in a plane perpendicular to the rotation axis of the body and the grinding device further has an outer periphery isolated from rotation of the body by bearings.

### FIELD OF THE INVENTION

The present invention relates to a grinding device, and particularly to a grinding device for removing a collapsed liner inside a pipe.

### BACKGROUND OF THE INVENTION

Installed pipelines in buildings and underground can be rehabilitated without opening structures or digging the ground. The trenchless rehabilitation allows a quick and durable rehabilitation of pipes within buildings and underground pipelines. A resin impregnated liner is installed in a pipe with an inversion drum using air pressure to invert the liner into the pipe. Once the liner is installed air pressure is maintained on an elevated level until the resin within the liner settles and the liner forms a rigid pipe against the inner surface of the old pipe. A drop in air pressure inside the pipe during a settling period may cause collapse of the liner which blocks or at least severely restricts the flow of fluids in the pipe. Once the collapsed liner has settled inside the pipe it can only be removed by mechanically sanding or grinding the collapsed liner into small fragments which can then be removed from the pipe.

One of the problems associated with the above arrangement is that it is tedious and hard work which may take several weeks to finish for a long pipe and it causes significant delays and additional expenses to a rehabilitation project.

### BRIEF DESCRIPTION OF THE INVENTION

An object of the present invention is to provide a grinding device which significantly speeds up the removal of a collapsed liner and other hard blockages from a pipe.

The present invention is based on the idea of providing grinding cutters on a body that can be rotated so that the grinding cutters can be used for a planar cutting surface. A ring enveloping the body and bearings between the body and the ring are provided so that the rotation of the body does not rotate the outmost ring.

An advantage of the arrangement of the present invention is that a device that has a planar cutting surface is insensitive to irregularities of the material to be ground so it does not seek its way in a certain direction as is done by e.g. a drill bit when facing an irregular surface. A planar cutting surface also makes it possible to design a short device which is capable of passing corners and tight bends inside a pipe. The outmost ring, separated with bearings from the body, ensures that rotation of the body and the grinding cutters does not harm the pipe inside which the grinding takes place because rotating parts are not in contact with the pipe.

### BRIEF DESCRIPTION OF THE DRAWINGS

In the following the present invention is described in greater detail by means of preferred embodiments with reference to the accompanying drawings, in which

FIG. 1 illustrates a forward side of a grinding device according to an embodiment of the present invention;

FIG. 2 illustrates a reverse side of a grinding device according to an embodiment of the present invention;

FIG. 3 shows a forward side view of a grinding device according to an embodiment of the present invention;

FIG. 4 shows a reverse side view of a grinding device according to an embodiment of the present invention; and

FIG. 5 shows a side view of a grinding device according to an embodiment of the present invention.

### DETAILED DESCRIPTION OF THE INVENTION

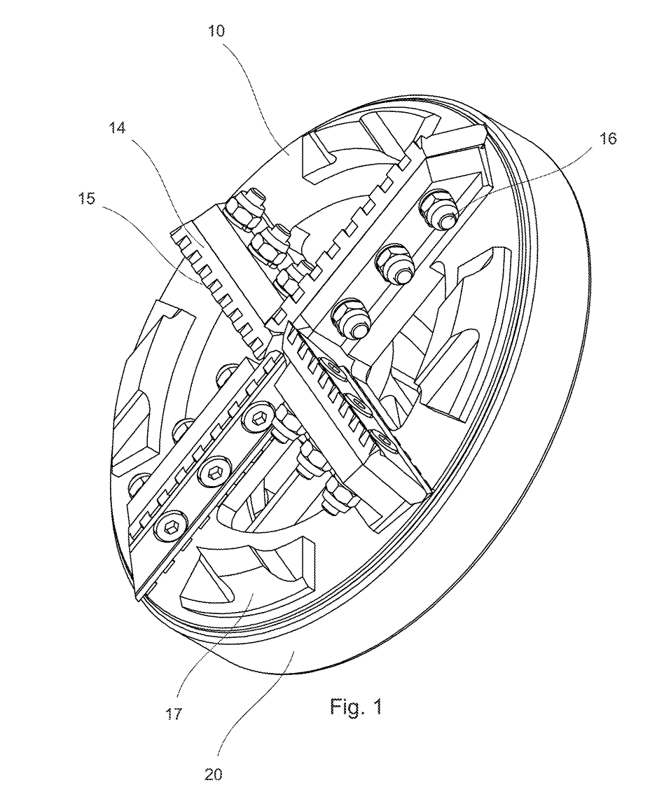

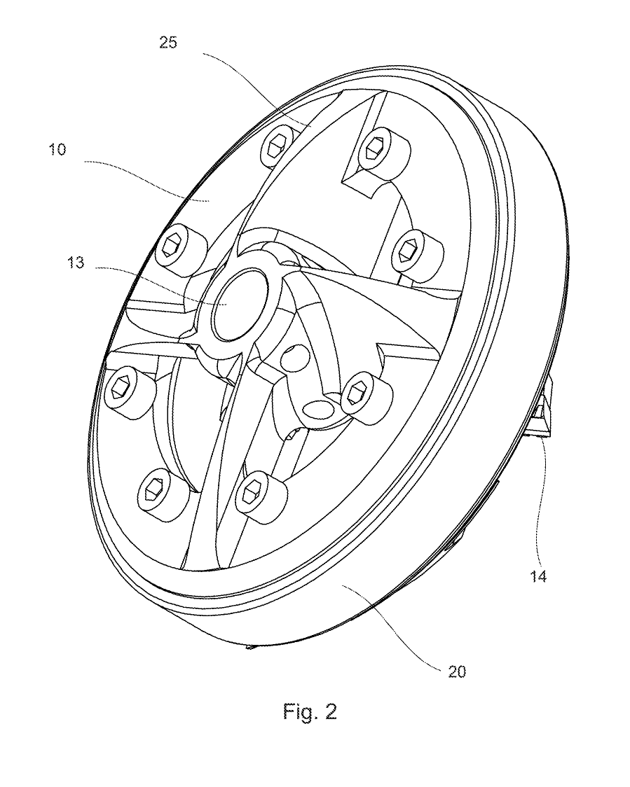

FIG. 1 is illustrates a forward side and FIG. 2 illustrates a backward side of a grinding device according to an embodiment of the present invention. The grinding device can be used in pipe rehabilitation work to remove obstacles and unwanted material, especially a collapsed liner, from a pipe.

The grinding device comprises a body (10) that has a connector (13) for a drive shaft. The body (10) is preferably made of a metal, such as aluminium or steel. The body may comprise multiple parts fixed together e.g. with screws and/or bolts and nuts. The connector (13) is preferably a socket that has a slightly larger diameter than the drive shaft. Preferably, two or more threaded apertures are provided on the side of the socket for accommodating tightening screws. The connector is provided on a reverse side of the grinding device so that the grinding device can be pushed forward in a pipe by pushing the drive shaft into the pipe. An end of the drive shaft is inserted into the socket and the drive shaft is secured to the connector by tightening the tightening screws against the drive shaft. The drive shaft is preferably made of a steel cable or similar drive shaft that has some flexibility to be able to bend through bends of a pipeline.

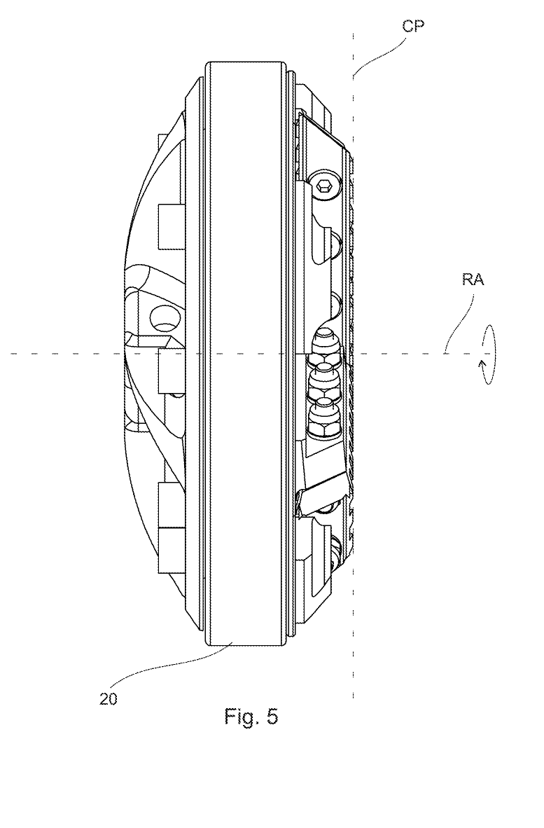

Once the drive shaft is secured to the connector (13), the grinding device can be operated by rotating the drive shaft. The rotation of the drive shaft rotates the body (10) of the grinding device around a rotation axis (RA) illustrated in FIG. 5. A powerful electric motor can be used for rotating the drive shaft. Depending on the diameter of the grinding device, electric motors that have an output of 2 to 10 kW and operating in a range of 500 to 2,500 rpm can be used with grinding devices that have a diameter from about 50 mm to about 150 mm. It is understood that the diameter may be less than 50 mm and more than 150 mm also.

The grinding device comprises grinding cutters (14) attached to the body (10). The grinding cutters are provided in a forward face of the grinding device so that the grinding cutters are the first parts hitting an obstacle in a pipe when the grinding device is pushed forward in the pipe. The grinding cutters (14) have cutting edges (15) which can be straight edges or preferably toothed edges. The grinding cutters are attached to the body in such a way that the cutting edges of the grinding cutters are in a plane that is perpendicular to the rotation axis (RA) of the body. This plane, i.e. a cutting plane (CP), is illustrated in FIG. 5. The planar cutting face is advantageous because it does not have a tendency of wandering or seeking its own way when facing a ridge or a recess in the material to be ground. For example, a conical cutting face has a strong tendency of seeking its way out of ridges and into recesses. Inside a pipeline a conical cutting face would force the body to tilt when facing an uneven or irregular surface as the pipe would prevent any significant lateral movement of the body. The grinding device has a planar cutting face that does not have this problem as it is quite insensitive to irregularities within the material to be ground. A small tilting force may act on the body but the body has relatively large angular momentum which overcomes the possible small tilting force.

The grinding cutters (14) are preferably attached to the body (10) with screws or bolts (16) for allowing replacement of worn out grinding cutters. Protrusions or supports, that have smooth or threaded holes for screws or bolts, can be provided on the body to facilitate the attachment and removal of the grinding cutters.

Preferably, there are four radially, or substantially radially, extending grinding cutters arranged on the body. It is advantageous to position the grinding cutters symmetrically to the rotation axis to prevent shaking of the device during operation. Larger diameter grinding devices may have more grinding cutters compared to smaller diameter grinding devices to prevent long gaps between the grinding cutters near an outer periphery of the body. Spacers (17) are preferably provided on the body between the grinding cutters (14) for defining a clearance between the spacers and the cutting plane (CP) of the cutting edges of the grinding cutters. The clearance restricts a maximum cutting depth of the grinding device to the clearance. For example, the grinding cutters may protrude 20 mm from the body in the forward direction which might cause a jam if the grinding cutter is pushed against an obstacle with a significant force. Therefore, spacers that have height of 15 mm are provided on the forward face of the body between the grinding cutters thereby defining a 5 mm clearance between cutting edges and spacers. With the spacers, the grinding cutters can only cut to the depth of 5 mm at a time which requires much less power than cutting away 20 mm deep chunks of the obstacle. The clearance is preferably between 1 and 10 mm, more preferably between 3 and 8 mm and most preferably between 5 and 7 mm.

The grinding device also comprises an outer periphery (20) isolated from rotation of the body (10) by bearings. For example, ball bearings or linear bearings can be used between the outer periphery (20) and the body (10) to prevent the body from rotating the outer periphery. In case the outer periphery is not in contact with anything, the rotation of the body might cause the outer periphery to rotate regardless of the bearings but only a small force on the outer periphery is needed to stop the rotation as friction between the body and the outer periphery is very small. The outer periphery, preferably, comprises a solid and rigid circular element, such as a metal ring, that forms its outmost surface from the rotation axis (RA). When the grinding device is pushed inside a pipe, the grinding device rests on the bottom of the pipe. The metal ring in this case would be in contact with the pipe and remains stationary while the rotating body and the grinding cutters are not in contact with the pipe so the pipe would not get damaged. As explained above, even with the planar cutting face, the grinding device may experience some lateral movement when pushed forward in a pipe so that the grinding cutters face an irregular surface blocking the pipe. This lateral movement can move the grinding device to any radial direction in the pipe until the grinding device makes contact with inner surface of the pipe. The metal ring, being the outmost part in radial direction of the grinding device, makes contact with the inner surface of the pipe but does not damage the inner surface of the pipe as it is stationary. The metal ring effectively prevents the rotating parts from hitting the inner surface of the pipe thereby protecting the pipe itself. The grinding cutters extend close to but not past the outer periphery for this reason.

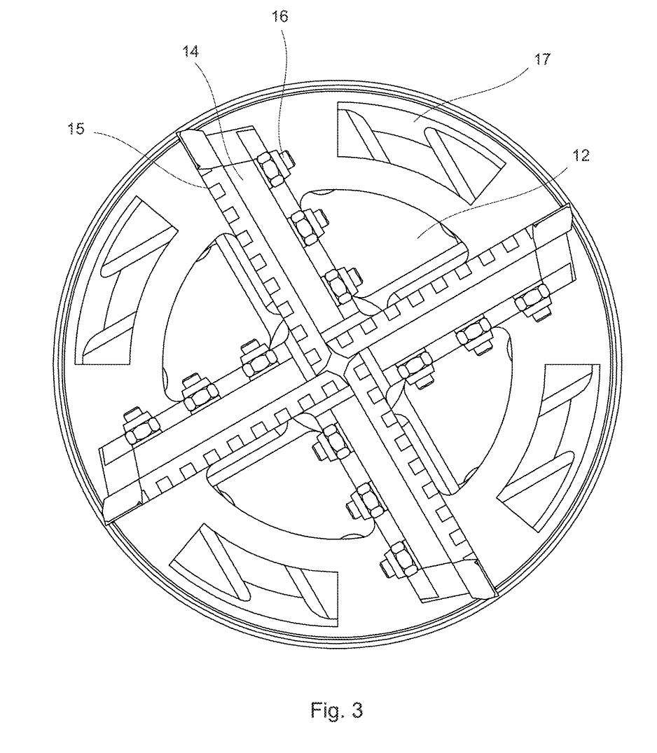

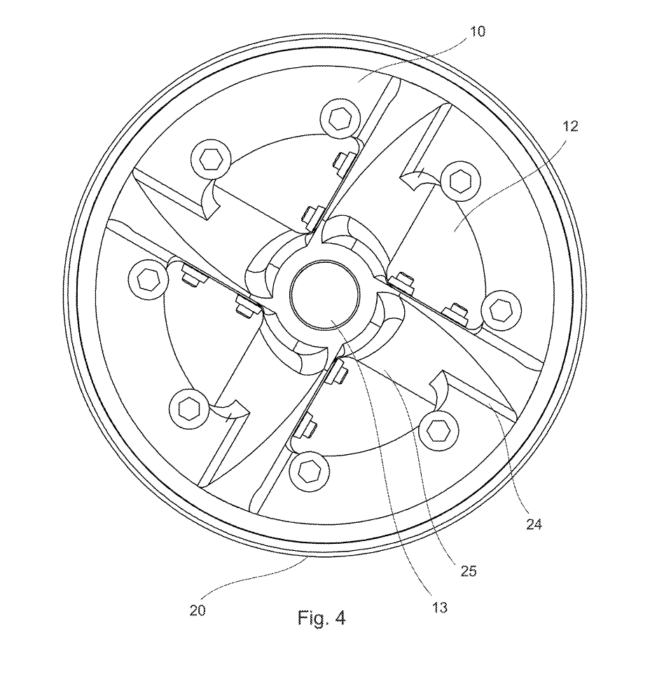

FIGS. 3, 4 and 5 show the grinding device according to an embodiment of the present invention viewed from the forward side, reverse side and side, respectively. Apertures (12) extending through the body (10) in the direction of rotation axis (RA) can be seen in FIGS. 3 and 4. The grinding device grinds a lot of small fragments of an obstacle that it is facing as the grinding device is operated inside a pipe. The grinding cutters may be clogged by the fragments if those fragments cannot escape between the grinding cutters. The grinding device has preferably a diameter smaller than inner diameter of a pipe where the grinding device is operated so there is a gap between the grinding device and the inner surface of the pipe. Some fragments will move through that gap from the forward side to the reverse side. However, the movement of the fragments can be increased with the apertures (12) on the body (10) which allows the fragments to move through them from the forward side to the reverse side of the grinding cutter. This movement of fragments can be increased by providing propeller blades (25) on the reverse side of the body next to the apertures (12) or on the edge of the apertures (12). The propeller blades may be configured to blow air through the apertures thereby blowing the fragments through the gap between the grinding device and the inner surface of the pipe with the blown air. The propeller blades may be configured to suck air through the apertures thereby causing a blow of air through the gap between the grinding device and the inner surface of the pipe to the forward side and sucking the fragments with the air through the apertures (12).

Under certain circumstances, the grinding device may move past a small obstacle in a pipe due to e.g. significant force pushing the grinding device forward accompanied with the lateral movement of the grinding device. The remaining small obstacle may block movement of the grinding device when the work is finished and the grinding device is removed in the reverse direction from the pipe by pulling from the drive shaft. The reverse face of the body of the grinding device can be provided with another set of grinding cutters in order to solve this problem. These reverse grinding cutters (24) are provided on the body opposite to the grinding cutters, i.e. on the reverse side of the body. When reversing with the grinding device by pulling from the drive shaft, these reverse grinding cutters (24) make contact with any obstacles and thereby grinding them and ultimately allowing the removal of the grinding device from the pipe in the reverse direction. The reverse grinding cutters may be provided on the propeller blades (25) or as separate parts with or without propeller blades on the body. The reverse grinding cutters can be smaller and shorter than the grinding cutters (14) on the forward face of the body as there cannot be any remaining large obstacles in a pipe which already has been cleared once in the forward direction with the grinding device. The reverse grinding cutters (25) are thus provided near the outer periphery of the body but not near the rotation axis.

It will be obvious to a person skilled in the art that, as the technology advances, that the inventive concept can be implemented in various ways. The present invention and its embodiments are not limited to the examples described above but may vary within the scope of the claims.

1. A grinding device for removing a collapsed liner inside a pipe, the grinding device comprising:
a connector for a drive shaft;
a body rotatable around a rotation axis with the drive shaft and grinding cutters attached to the body;
the grinding cutters having cutting edges provided in a plane perpendicular to the rotation axis of the body; and
the grinding device having an outer periphery isolated from rotation of the body by bearings.

2. The grinding device of claim 1, wherein the outer periphery is a continuous circular metal ring.

3. The grinding device of claim 1, wherein four radially extending grinding cutters are arranged on the body symmetrically to the rotation axis.

4. The grinding device of claim 1, wherein spacers are provided on the body between the grinding cutters for defining a clearance between the spacers and the plane of the cutting edges of the grinding cutters, the clearance restricting a maximum cutting depth of the grinding device to the clearance.

5. The grinding device of claim 1, wherein the body has apertures defined therein and the apertures extend through the body in a direction of the rotation axis of the body for preventing clogging of the grinding cutters.

6. The grinding device of claim 1, wherein propeller blades are provided on the body for increasing a flow of air through the apertures and for preventing clogging of the grinding cutters by blowing away fragments of ground material.

7. The grinding device of claim 1, wherein the outer periphery is further away from the rotation axis of the body than the cutting surfaces.

8. The grinding device of claim 1, wherein the grinding cutters are attached to the body with screws or bolts for allowing replacement of worn out grinding cutters.

9. The grinding device of claim 1, wherein reverse grinding cutters are provided on the body opposite to the grinding cutters.
